(19) United States
(12) Patent Application Publication
(10) Pub. No.: US 2010/0130211 A1
(43) Pub. Date: May 27, 2010

(54) HANDOVER DETERMINATION APPARATUS AND METHOD IN OVERLAY WIRELESS NETWORK ENVIRONMENT

(75) Inventors: Jung-sook Bae, Daejeon-si (KR); Dae-ho Kim, Daejeon-si (KR); Yeong-jin Kim, Daejeon-si (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon-si (KR)

(21) Appl. No.: 12/580,054

(22) Filed: Oct. 15, 2009

(30) Foreign Application Priority Data
Nov. 24, 2008 (KR) 10-2008-0117067

(51) Int. Cl. H04W 36/00; H04W 36/24

(52) U.S. Cl. 455/438; 370/332

(57) ABSTRACT

A handover determination apparatus and method in an overlay wireless network environment is provided. A handover situation is detected with consideration of a user environment including user requirements and service efficiency, as well as received signal strength of a wireless network, and an unnecessary handover due to a temporary condition change is prevented by use of a dwell timer. Accordingly, a seamless optimized wireless network service can be provided to a user regardless of a location of the user.

### CROSS REFERENCE TO RELATED APPLICATION

This application claims the benefit under 35 U.S.C. §119(a) of Korean Patent Application No. 10-2008-0117067, filed on Nov. 24, 2008, the disclosure of which is incorporated herein in its entirety by reference.

### BACKGROUND

1. Field

The following description relates to a handover determination apparatus and method in an overlay wireless network environment, and more particularly, to a technology for determining handover in consideration of a user environment in an overlay wireless network environment which has a plurality of wireless networks converging together based on an IP-based core network.

2. Description of the Related Art

Conventionally, handover is performed by restricting a range of handover to a wireless network overlay area and connecting a mobile terminal to a wireless network having a stronger received signal strength than a current wireless network in the overlay area.

However, in the conventional handover method, since the handover is determined by the received signal strength, that is, a wireless network environment, a user oriented handover service in consideration of a user environment such as user requirements and service efficiency could not be provided.

In addition, once handover requirements based on the received signal strength are satisfied, an immediate handover is performed, and thus a ping-pong effect frequently occurs even in a short period of time by a temporary change in a corresponding wireless environment, thereby causing service performance deterioration.

The next-generation mobile communication network is configured by a plurality of wireless networks including a wireless network for high-speed data transfer, an existing wide-area cellular wireless network, a local-area wireless network and the like which are converging together based on an Internet protocol (IP)-based core network, and has an overlaying service area where these several wireless networks overlay one another. In the next-generation mobile communication network, a mobile terminal can be connected with various forms of overlay wireless networks as it is moving.

Therefore, to provide a user with seamless and optimized wireless network service regardless of a location of the user in the next-generation mobile communication network, i.e., the overlay wireless network environment, a handover determination method is required in which a handover situation is detected by taking into consideration a user environment including user requirements and service efficiency, as well as a received signal strength of a currently connected wireless network, and unnecessary handover due to a temporary change in conditions is prevented to reduce a ping-pong effect.

### SUMMARY

Accordingly, in one aspect, there is provided a handover determining apparatus and method by which handover is performed with consideration of a user environment and an unnecessary handover due to a temporary change in conditions (hereinafter referred to as “a temporary condition change”) is prevented in an overlay wireless network environment where a plurality of wireless networks converge together based on an Internet protocol (IP)-based core network and have overlying service areas.

In one general aspect, there is provided an apparatus for determining handover in an overlay wireless network environment. The apparatus forms a service available cell group from cells to which a multi-mode terminal is accessible in the overlay wireless network environment, based on a received signal strength indicator (RSSI) of a signal received from the multi-mode terminal, calculates a user environment-based service efficiency with respect to each cell belonging to the service available cell group, forms a satisfactory service cell group based on a difference between the calculated service efficiency of each cell and service efficiency of a cell to which the multi-mode terminal is currently connected, determines when to perform handover using a dwell timer in order to prevent unnecessary handover caused by a temporary condition change, forms the candidate service cell group including cells belonging to both a satisfactory service cell group that is formed before the dwell timer is activated and a satisfactory service cell group that is formed after the dwell timer is activated, and selects the cell from the candidate service cell group to determine the target cell to which the handover is performed.

The handover situation is detected and the resultant handover is performed with consideration of user environment including user requirements and service efficiency, as well as an RSSI of a wireless network, and an unnecessary handover caused by a temporary condition change is prevented by use of the dwell timer, and thereby a ping-pong effect can also be reduced. Therefore, regardless of a location of the user, a seamless and optimized wireless network service can be provided to the user.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating an overlay wireless network.

FIG. 2 is a block diagram illustrating a handover determining apparatus in an overlay wireless network environment according to an exemplary embodiment.

FIG. 3 is a flowchart illustrating a method of determining handover in the overlay wireless network according to an exemplary embodiment.

FIG. 4 is a flowchart illustrating an example of a handover determining operation.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In the following description, a detailed description of known functions and configurations incorporated herein will be omitted when it may obscure the subject matter with unnecessary detail.

Before describing the exemplary embodiments, terms used throughout this specification are defined. These terms are defined in consideration of functions according to exemplary embodiments, and can be varied according to a purpose of a user or manager, or precedent and so on. Therefore, definitions of the terms should be made on the basis of the overall context.

An overlay wireless network is a wireless network formed by a plurality of different kinds of wireless networks, such as a wireless network for high speed data transfer, an existing wide area cellular wireless network and a local-area wireless network, which are converging based on an Internet protocol (IP)-based core network and have overlaying service areas.

A multi-mode terminal is a mobile terminal that is accessible to each of the wireless network in an overlay wireless network environment.

A user environment-based service efficiency refers to a factor for determining handover, which is calculated based on user requirement information, user service environment information, cell status information, and service rate information.

A dwell timer is for setting a delay time in order to prevent unnecessary handover caused by a temporary change in conditions (hereinafter referred to as “a temporary condition change”). Cells that belong to both a satisfactory service cell group that is formed before the dwell timer is activated and a satisfactory service cell group that is formed after the dwell timer is activated are extracted and a candidate service cell group is formed using the extracted cells. One of cells from the candidate service cell group is selected as a target cell to which handover is to be performed.

A service available cell group refers to a group of multi-mode terminal accessible cells among the wireless network cells in the overlay wireless network, each of the accessible cells receiving a signal from the multi-mode terminal and a received signal strength indicator (RSSI) of the signal being greater than a first reference value.

A satisfactory service cell group refers to a group of cells, each of which has a calculated service efficiency greater than a second reference value.

The candidate service cell group refers to a group of cells belonging to both the satisfactory service cell group formed before the dwell timer is activated and the satisfactory service cell group formed after the dwell timer has expired.

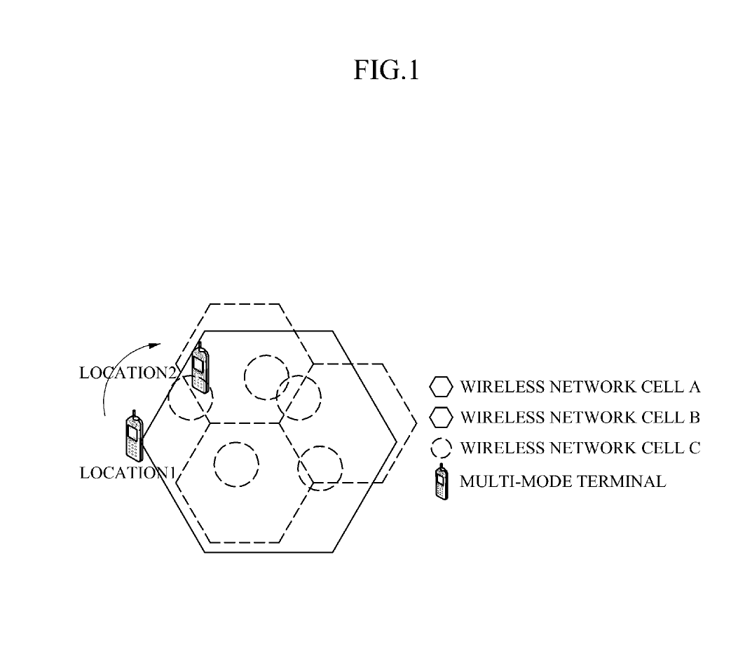

FIG. 1 is a diagram illustrating an overlay wireless network. Referring to FIG. 1, cells overlay one another in various forms according to locations of wireless network base stations in an overlay wireless network environment. As shown in FIG. 1, a wireless network cell A, wireless network cells B and wireless cells C have overlaying service areas.

As the multi-mode terminal moves from a location 1 to a location 2, a user environment changes with respect to each cell. In the exemplary embodiment, to provide a seamless optimized wireless network service regardless of the location of the multi-mode terminal, a handover situation is detected by taking into consideration a user environment including requirements of a user and a service efficiency, as well as an RSSI of the wireless network cell.

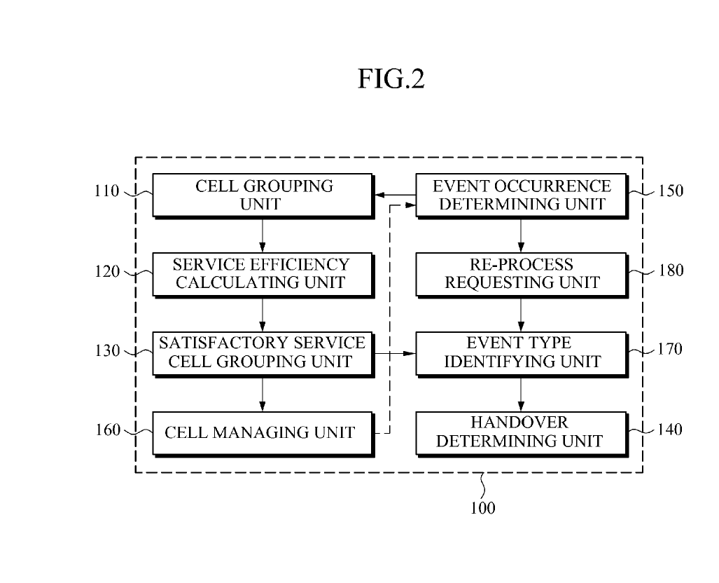

FIG. 2 is a block diagram illustrating a handover determining apparatus 100 in an overlay wireless network environment according to an exemplary embodiment. The handover determining apparatus 100 may be implemented as a piece of hardware or software or a combination of the two which is mounted in a base station which the multi-mode terminal is currently connected to. The handover determining apparatus 100 includes a service available cell grouping unit 110, a service efficiency calculating unit 120, a satisfactory service cell grouping unit 130, and a handover determining unit 140.

The service available cell grouping unit 110 compares an RSSI of a signal, which is received by each of the accessible cells in the wireless network environment from the multi-mode terminal, with the first reference value, extracts cells that have an RSSI greater than the first reference value, and forms a service available cell group including the extracted cells.

The multi-mode terminal cyclically measures and manages an RSSI of each of the wireless network cells. In addition, for performing handover reflecting the user environment, a base station to which the multi-mode terminal is currently connected requests the multi-mode terminal to measure and report the RSSI of each of the accessible cells every time a handover determination cycle arrives.

When the RSSI of each of the accessible cells is reported by the multi-mode terminal, the handover determining apparatus 100 uses the service available cell grouping unit 110 to compare the RSSI of each accessible cell with the first reference value, and extracts cells that have an RSSI greater than the first reference value to form the service available cell group.

If each cell is denoted by represents a wireless network and ‘j’ is a positive integral number that represents each cell) and the first reference value is TH1, cells that satisfy RSSI(Cᵢⱼ)>TH1 are extracted to form a service available cell group S.

The service efficiency calculating unit 120 calculates a user environment-based service efficiency of each of the cells belonging to the formed service available cell group.

In this case, the user environment-based service efficiency may be calculated on the basis of user requirement information including information about user network preference, a required bandwidth, user service environment information including information about a user's average speed and characteristics of a currently used service, cell status information including cell load information, RSSI information and information about a provided bandwidth, and a user environment information including service rate information. The user environment information may be obtained by a mobile communication system or a user's setting. The detailed description of acquisition of the user environment information will not be provided since it does not fall under the scope of the present invention.

For example, if a function for calculating a user environment-based service based on the user environment information is denoted by f(x) and each of the cells belonging to the service available cell group S is denoted by Sᵢ (‘i’ represents a positive integral number greater than 0), the user environment-based service efficiency of each cell belonging to the service available cell group may be represented by f(Sᵢ).

The satisfactory service cell grouping unit 130 forms a satisfactory service cell group according to a difference between the calculated service efficiency of each cell and a service efficiency of a cell to which the multi-mode terminal is currently connected.

In this case, the satisfactory service cell grouping unit 130 compares the difference between the calculated service efficiency of each cell and the service efficiency of the current connected cell with a second reference value, extracts the cells having a difference greater than the second reference value to from the satisfactory service cell group.

For example, a service efficiency of each of the cells belonging to the service available cell group is represented by f(Sᵢ), a service efficiency of the cell to which the multi-mode terminal is currently connected is represented by f(C_{current}) and the second reference value is represented by TH2, cells that satisfy f(Sᵢ)−f(C_{current})>TH2 are extracted to form the satisfactory service cell group S_{current}.

The handover determining unit 140 determines one of cells belonging to the candidate service cell group as a target cell to which handover is to be performed.

In addition, the handover determining unit 140 may determine when to perform handover using a dwell timer in order to prevent the unnecessary handover caused by a temporary condition change, extract cells belonging to both the satisfactory service cell group that is formed before the dwell timer is activated and the satisfactory service cell group that is formed after the dwell timer has expired, form the candidate service cell group, and select one of the cells belonging to the formed candidate service cell group as the target cell to which the handover is to be performed.

For example, the satisfactory service cell group formed before the dwell timer is activated is denoted by S_{before}, the satisfactory service cell group formed after the dwell timer has expired is denoted by S_{current} and the candidate service cell group is denoted by Sₕₒₜ, the candidate service cell grout includes cells that satisfy Sₕₒₜ=S_{current} ∩S_{before}.

The handover determining unit 140 may detect whether cells are present in the candidate service cell group. When it is found that the cells are in the candidate service cell group, the handover determining unit 140 may arrange the cells in the candidate service cell group in order from high to low service efficiency, and issue handover authentication requests for the multi-mobile terminal to the cells in the arranged order and determines a cell that authenticates the handover as the target cell. If it is found that no cell is present in the candidate service cell group, a re-process requesting unit 180 is activated, which will be described later.

In the exemplary embodiment, the handover determining apparatus 100 in the overlay wireless network environment detects a handover situation by taking into consideration a user environment including requirements of a user and a service efficiency, as well as an RSSI of the wireless network cell. Also, the handover determining apparatus 100 determines a target cell by selecting a cell with a highest service efficiency from the cells belonging to both the satisfactory service cell group that is formed before the dwell timer is activated and the satisfactory service cell group that is formed after the dwell timer has expired in the order, and performs handover to the target cell with consideration of the user environment. The dwell timer is used to prevent unnecessary handover caused by a temporary condition change. Therefore, a ping-pong effect can be reduced, and consequently continuous optimized wireless network service can be provided to the user regardless of a location of the user.

In another exemplary embodiment, the handover determining unit 100 may further include an event occurrence determining unit 150. The event occurrence determining unit 150 determines whether a dwell timer expiration event or a handover determination cycle arrival event occurs, and signals to the service available cell grouping unit 110 when any event occurs.

That is, since the satisfactory service cell groups are formed respectively before and after the dwell timer is activated in order to prevent an unnecessary handover caused by a temporary condition change, it is required to determine whether the service available cell group is formed due to the dwell timer expiration event or due to the handover determination cycle arrival event.

Such determination is performed by the event occurrence determining unit 150.

In addition, the handover determining apparatus 100 may further include a cell managing unit 160. The cell managing unit 160 maintains a cell to which the multi-mode terminal is currently connected and promotes the occurrence of the handover determination cycle event when it is found that no cell is present in the satisfactory service cell group.

Specifically, when the satisfactory service cell group formed with consideration of the user environment does not include any cell better than the cell currently connected to the multi-mode terminal, the multi-mode terminal is not handed over and maintains its connection with the current cell, and the handover determination cycle event occurrence is promoted so that a handover operation can be started when the next handover determination cycle arrives.

The handover determining apparatus 100 may further include an event type identifying unit 170. When it is determined that a cell is present in the formed satisfactory service cell group, the event type identifying unit 170 determines whether handover is to be performed due to dwell timer expiration, and signals to the handover determining unit 140 if it is determined that the handover is to be performed due to the dwell timer expiration.

In other words, the satisfactory service cell groups are formed respectively before and after the dwell timer is activated in order to prevent an unnecessary handover caused by a temporary condition change, handover is determined to be performed when the service available cell group is formed due to the dwell timer expiration event occurrence, and the dwell timer should be activated to reconstruct the service available cell group when the service available cell group is formed due to the handover determination cycle arrival event occurrence.

To this end, the handover determining apparatus 100 uses the event type identifying unit 170 to determine whether the handover is to be performed due to the dwell timer expiration, and signals to the handover determining unit 140 to select a target cell when it is determined that the handover is performed due to the dwell timer expiration, or otherwise, reconstructs the satisfactory service cell group.

The handover determining apparatus 100 may further include the re-process requesting unit 180. When it is determined that the handover is not to be performed due to the dwell timer expiration, the re-process requesting unit 180 stores a current satisfactory service cell group into a previous satisfactory service cell group, activates the dwell timer, and inactivates occurrence of the handover determination cycle event so as to request the satisfactory service cell grouping unit 130 to reconstruct a satisfactory service cell group.

In other words, as described above, the satisfactory service cell groups are formed respectively before and after the dwell timer is activated in order to prevent an unnecessary handover caused by a temporary condition change, handover is determined to be performed when the service available cell group is formed due to the dwell timer expiration event occurrence, and the dwell timer is activated to reconstruct the service available cell group when the service available cell group is formed due to the handover determination cycle arrival event occurrence.

To reconstruct the service available cell group, when it is determined that the handover is not to be caused by the dwell timer expiration, the handover determining apparatus 100 uses the re-process requesting unit 180 to store the current satisfactory service cell group S_{current} into the previous satisfactory service cell group S_{before}, activates the dwell timer, and inactivates the occurrence of the handover determination cycle event in order to prevent handover determination due to the handover determination cycle event, and only reconstructs the satisfactory service cell group.

Therefore, as described above, the handover determining apparatus 100 detects a handover situation and performs handover by taking into consideration the user environment including the user requirements and the service efficiency, as well as the RSSI with respect to the wireless network. However, at the same time, the handover determining apparatus 100 prevents an unnecessary handover caused by a temporary condition change, thereby reducing a ping-pong effect. Accordingly, a user can be provided with seamless optimized wireless network services.

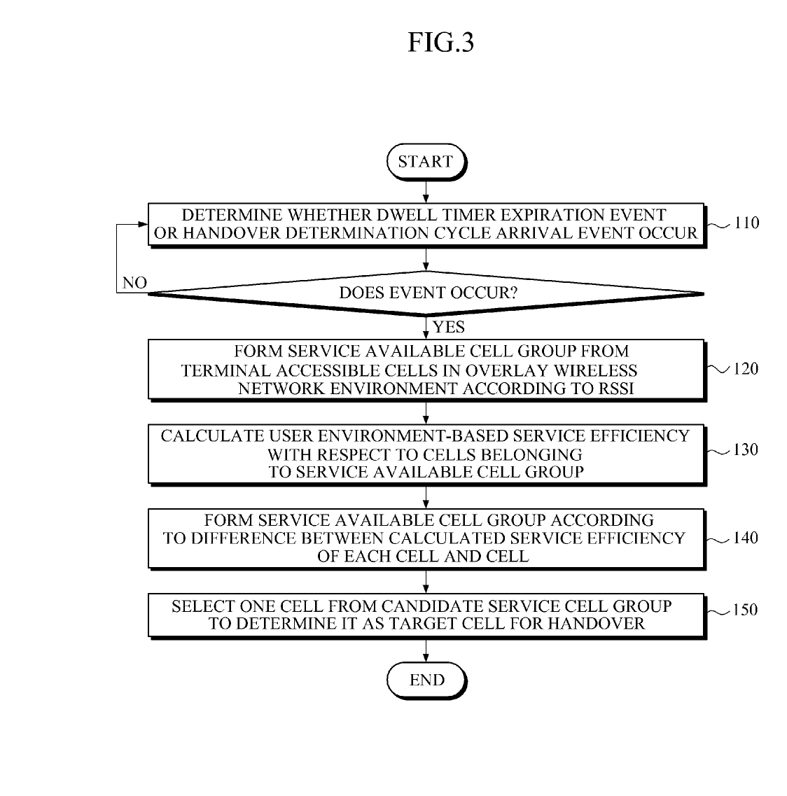

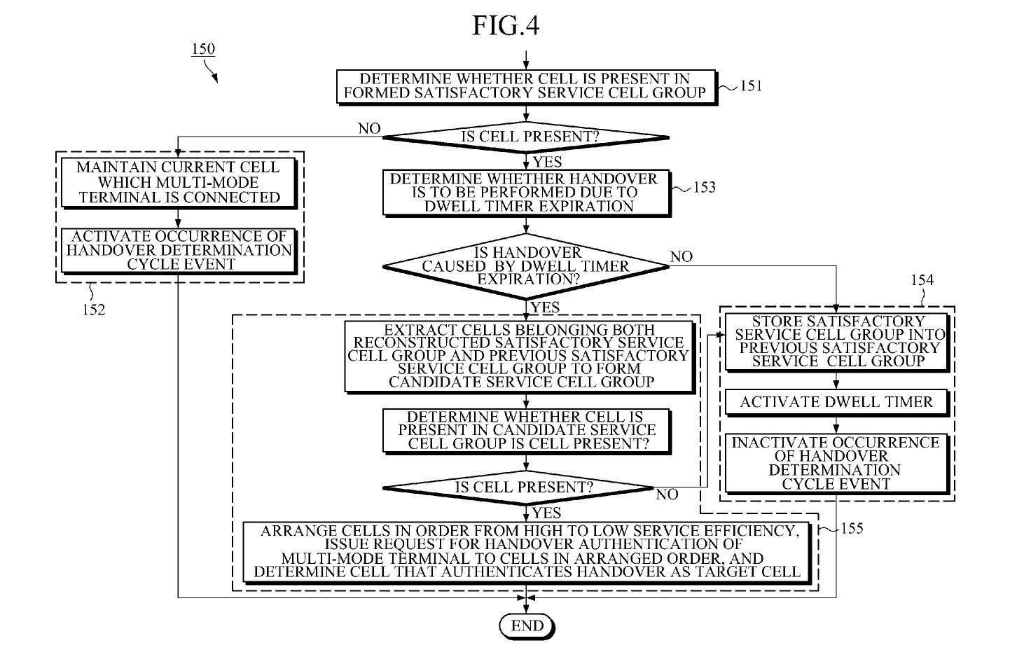

A handover determining operation of a handover determining apparatus in an overlay wireless network environment will be described with reference to FIGS. 3 and 4.

FIG. 3 is a flowchart illustrating a method of determining handover in the overlay wireless network according to an exemplary embodiment. FIG. 4 is a flowchart illustrating an example of a handover determining operation.

The multi-mode terminal cyclically measures and manages an RSSI of each of the wireless network cells. In addition, for performing handover reflecting the user environment, a base station to which the multi-mode terminal is currently connected requests the multi-mode terminal to measure and report the RSSI of each of the accessible cells every time a handover determination cycle arrives.

Referring to FIG. 3, it is determined whether a dwell timer expiration event or a handover determination cycle arrival event occurs in order to detect a handover situation with consideration of a user environment including user's requirements and a service efficiency as well as the RSSI with respect to the wireless network (operation 110).

When it is determined that any event occurs, the base station forms a service available cell group from cells to which the multi-mode terminal is accessible to according to the RSSI (operation 120).

In this case, the base station may compare the RSSI of each of the accessible cells with the first reference value, and extract cells, each having an RSSI greater than the first reference value, to form the service available cell group.

Once the service available cell group is formed in operation 120, the base station calculates a user environment-based service efficiency with respect to each cell belonging to the service available cell group (operation 130).

At this time, the user environment-based service efficiency may be calculated on the basis of user requirement information including information about user network preference, a required bandwidth, user service environment information including information about a user's average speed and characteristics of a currently used service, cell status information including cell load information, RSSI information and information about a provided bandwidth, and a user environment information including service rate information. Information about the user environment may be obtained by a mobile communication system or user settings.

When the service efficiency of each cell belonging to the service available cell group is calculated in operation 130, the base station forms a satisfactory service cell group according to a difference between the calculated service efficiency of each cell and a service efficiency of a cell to which the multi-mode terminal is currently connected (operation 140).

At this time, cells, each having a difference between the calculated service efficiency and the service efficiency of the currently connected cell greater than a second reference value, are extracted to form the satisfactory service cell group.

Then, a cell is selected from a candidate service cell group and is determined as a target cell (operation 150).

In this case, the base station may determine when to perform handover using a dwell timer in order to prevent the unnecessary handover caused by a temporary condition change, extract cells belonging to both the satisfactory service cell group formed before the dwell timer is activated and the satisfactory service cell group formed after the dwell timer has expired, form the candidate service cell group, and select one of the cells belonging to the formed candidate service cell group as the target cell to which the handover is to be performed.

In operation 150, the cells belonging to the candidate service cell group may be arranged in order from high to low service efficiency, and handover authentication requests for the multi-mobile terminal may be issued in the arranged order to the cells, and a cell that authenticates the handover may be determined as the target cell.

As the result, a handover situation is detected and the resultant handover is performed with consideration of user environment including user requirements and service efficiency, as well as an RSSI of a wireless network, and an unnecessary handover caused by a temporary condition change is prevented by use of the dwell timer, and thereby a ping-pong effect can also be reduced. Therefore, regardless of a location of the user, a seamless and optimized wireless network service can be provided to the user.

As shown in FIG. 4, according to another exemplary embodiment, specifically the determination of handover 150 is performed by the following operations. First, the base station determines whether any cells are present in the satisfactory service cell group formed in operation 140 (operation 151).

If no cell is present in the satisfactory service cell group, the base station maintains the connection between the current cell and the multi-mode terminal and promotes occurrence of a handover determination cycle event (operation 152).

If any cells are present in the satisfactory service cell group, the base station determines whether or not handover is to be performed due to dwell timer expiration (operation 153).

If it is determined that the handover is not to be performed due to dwell timer expiration, the base station stores the current satisfactory service cell group in a previous satisfactory service cell group, activates the dwell timer, and inactivates occurrence of the handover determination event so as to request the reconfiguration of the satisfactory service cell group (operation 154).

If it is determined that the handover is to be performed due to dwell timer expiration, the base station extracts cells belonging to both the reconstructed satisfactory service cell group and the previous satisfactory service cell group to form the candidate service cell group, determines whether any cells are present in the formed candidate service cell group, and, if present, arranges the cells in order from high to low service efficiency, issues handover authentication for the multi-mode terminal to the cells in the arranged order, and determines a cell that authenticates the handover as the target cell (operation 155). If no cell is present in the candidate service cell group, the procedure returns to operation 154.

Hence, the handover situation is detected and the resultant handover is performed with consideration of user environment including user requirements and service efficiency, as well as an RSSI of a wireless network, and an unnecessary handover caused by a temporary condition change is prevented by use of the dwell timer, and thereby a ping-pong effect can also be reduced. Therefore, regardless of a location of the user, a seamless and optimized wireless network service can be provided to the user.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for determining handover in an overlay wireless network environment, the apparatus comprising:
a service available cell grouping unit to form a service available cell group from cells to which a multi-mode terminal is accessible in the overlay wireless network environment, based on a received signal strength indicator (RSSI) of a signal received from the multi-mode terminal;
a service efficiency calculating unit to calculate a user environment-based service efficiency with respect to each cell belonging to the service available cell group;
a satisfactory service cell grouping unit to form a satisfactory service cell group based on a difference between the calculated service efficiency of each cell and service efficiency of a cell to which the multi-mode terminal is currently connected;
a handover determining unit to select a cell from a candidate service cell group to is determine a target cell to which handover is performed.

2. The apparatus of claim 1, wherein the service available cell grouping unit compares the RSSI of the signal that each accessible cell receives from the multi-mode terminal with a first reference value, extracts cells that have an RSSI greater than the first reference value from wireless network cells in the overlay network environment, and forms the service available cell group including the extracted cells.

3. The apparatus of claim 1, wherein the satisfactory service grouping unit compares a second reference value with a difference between the service efficiency of each cell calculated by the service efficiency calculating unit and the service efficiency of the cell to which the multi-mode terminal is currently connected, extracts cells of which the difference between the calculated service efficiency thereof and the service efficiency of the current cell is greater than the second reference value and forms the satisfactory service cell group including the extracted cells.

4. The apparatus of claim 1, wherein the handover determining unit determines when to perform handover using a dwell timer in order to prevent unnecessary handover caused by a temporary condition change, forms the candidate service cell group including cells belonging to both a satisfactory service cell group that is formed before the dwell timer is activated and a satisfactory service cell group that is formed after the dwell timer is activated, and selects the cell from the candidate service cell group to determine the target cell to which the handover is performed.

5. The apparatus of claim 1, wherein the user environment-based service efficiency is calculated based on user requirement information, user service environment information, cell status information, and service rate information.

6. The apparatus of claim 5, wherein the user requirement information includes pieces of information about a user network preference and a required bandwidth.

7. The apparatus of claim 5, wherein the user service environment information includes pieces of information about a user's average speed and characteristics of a currently used service.

8. The apparatus of claim 5, wherein the cell status information includes cell load information, RSSI information and information about a provided bandwidth.

9. The apparatus of claim 1, wherein the handover determining unit arranges the cells belonging to the candidate service cell group in order from high to low service efficiency, issues handover authentication requests for the multi-mobile terminal to the cells in the arranged order and determines a cell that authenticates the handover as the target cell.

10. The apparatus of claim 1, further comprising:
an event occurrence determining unit to determine whether a dwell timer expiration event or a handover determination cycle arrival event takes place and to inform the service available cell grouping unit when the event takes place.

11. The apparatus of claim 10, further comprising:
a cell managing unit to, when no cell is present in the satisfactory service cell group, maintain a connection between the current cell and the multi-mode terminal and promote occurrence of a handover determination cycle event.

12. The apparatus of claim 10, further comprising:
an event type identifying unit to, when a cell is present in the satisfactory service cell group, determine whether handover is to be performed due to the dwell timer expiration event and signal to the handover determining unit if it is determined that the handover is to be performed according to the dwell timer expiration event.

13. The apparatus of claim 12, further comprising:
a re-process requesting unit to, when it is determined that handover is not performed due to dwell timer expiration, store a current satisfactory service cell group in a previous satisfactory service cell group, activate the dwell timer and inactivate occurrence of the handover determination cycle event to request a reconfiguration of a satisfactory service cell group.

14. A method of determining handover in an overlay wireless network environment, the method comprising:
determining, at a base station, whether a dwell timer expiration event or a handover determination cycle arrival event occurs;
forming, at the base station, a service available cell group from cells to which a multi-mode terminal is accessible in the overlay wireless network environment, based on a received signal strength indicator (RSSI) of a signal received from the multi-mode terminal, when it is determined that either the dwell timer expiration event or the handover determination cycle arrival event occurs;
calculating, at the base station, a user environment-based service efficiency with respect to each cell belonging to the service available cell group;
is forming a satisfactory service cell group based on a difference between the calculated service efficiency of each cell and service efficiency of a cell to which the multi-mode terminal is currently connected;
determining a target cell by selecting a cell from a candidate service cell group.

15. The method of claim 14, wherein the forming of the service available cell group comprises comparing an RSSI of a signal that each accessible cell receives from the multi-mode terminal with a first reference value, extracting cells that have an RSSI greater than the first reference value from wireless network cells in the overlay network environment and forming the service available cell group including the extracted cells.

16. The method of claim 14, wherein the forming of the satisfactory service cell group comprises comparing a second reference value with a difference between the service efficiency of each cell calculated by the service efficiency calculating unit and the service efficiency of the cell to which the multi-mode terminal is currently connected, extracting cells of which the difference between the calculated service efficiency thereof and the service efficiency of the current cell is greater than the second reference value and forming the satisfactory service cell group including the extracted cells.

17. The method of claim 14, wherein the determining of the handover comprises determining when to perform handover using a dwell timer in order to prevent unnecessary handover caused by a temporary condition change, forming the candidate service cell group including cells belonging to both a satisfactory service cell group formed before the dwell timer is activated and a satisfactory service cell group formed after the dwell timer is activated, and selecting the cell from the candidate service cell group to is determine the target cell to which the handover is performed.

18. The method of claim 14, wherein the user environment-based service efficiency is calculated based on user requirement information, user service environment information, cell status information, and service rate information.

19. The method of claim 18, wherein the user requirement information includes pieces of information about a user network preference and a required bandwidth.

20. The method of claim 18, wherein the user service environment information includes pieces of information about a user's average speed and characteristics of a currently used service.
